(19) United States
(12) Patent Application Publication
(10) Pub. No.: US 2025/0115048 A1
(43) Pub. Date: Apr. 10, 2025

(54) Print Group for an Inkjet Printing Device

(71) Applicant: Canon Production Printing Holding B.V., Venlo (NL)

(72) Inventor: Admir Lela, Haar (DE)

(21) Appl. No.: 18/906,432

(22) Filed: Oct. 4, 2024

(30) Foreign Application Priority Data
Oct. 6, 2023 (DE) 10 2023 127 241.1

(51) Int. Cl. B41J 2/165; B41J 29/377

(52) U.S. Cl. CPC B41J 2/16511; B41J 29/377; B41J 2002/16594

(57) ABSTRACT

A print group for an inkjet printing device is described that has at least one print bar with a cover unit for the print bar. The cover unit covers the print bar with an ambient climate produced by a conditioning liquid when the print bar is arranged in its park position. The print group also includes an aeration unit that is connected with the cover unit via an aeration line. The aeration unit is arranged so high above the conditioning liquid that, upon transferring the print bar into the park position, no conditioning liquid can arrive at the aeration unit via the aeration line.

### CROSS-REFERENCE TO RELATED APPLICATION

This application claims priority to German Patent Application No. 10 2023 127 241.1 filed Oct. 6, 2023, the disclosure of which is hereby incorporated by reference in its entirety.

### BACKGROUND OF THE INVENTION

### Field of the Invention

The invention relates to a print group for an inkjet printing device that, for the one or more print bars of the print group, has a respective cover unit to cover the nozzle plates of the one or more print heads of the individual print bars.

### Description of Related Art

An inkjet printing device for printing to a recording medium comprises at least one print group having at least one print bar, wherein the print bar has one or more print heads having respectively one or more nozzles. The individual nozzles are respectively configured to eject ink droplets in order to print dots of a print image onto the recording medium.

If the printing process of the inkjet printing device is interrupted, the print bar can be transitioned into a park position in which the nozzle plates of the one or more print heads of the inkjet printing device are covered in order to avoid a drying up of the nozzles of the one or more print heads during the printing pause.

### SUMMARY OF THE INVENTION

The present document deals with the technical object of providing a particularly efficient and durable covering of the nozzle plates of the one or more print heads of the print bar of a print group of an inkjet printing device. The object is respectively achieved via the features as described herein.

According to one aspect, a print group for an inkjet printing device is described. The print group comprises at least one print bar having at least one print head, as well as a cover unit for the print bar. In the park position of the print bar, the cover unit is designed to cover the nozzle plate of the print head of the print bar with a container, and to receive conditioning liquid into the container, wherein a defined ambient climate is typically produced within the container via the conditioning liquid.

The print group also comprises an aeration unit that is connected in an air-conducting manner with the fill opening of the container of the cover unit. The aeration unit is arranged with a height difference above the fill opening, wherein the height difference is of such a height that conditioning liquid that is pressed through the fill opening into the aeration line upon transferring the print bar into the park position cannot reach the aeration unit.

According to a further aspect, a print group for an inkjet printing device is described, wherein the print head comprises a plurality of print bars, and wherein the individual print bars of the plurality of print bars respectively comprise at least one print head. The print group also comprises a plurality of cover units for the corresponding plurality of print bars, wherein the individual cover units of the plurality of cover units are respectively designed to, in the park position of the respective print bar of the plurality of print bars, cover a nozzle plate of the print head of the respective print bar with a container, and receive conditioning liquid into the container of the respective cover unit.

The print group also comprises a common aeration unit and a plurality of aeration lines for the corresponding plurality of cover units, wherein the individual aeration lines of the plurality of aeration lines respectively connect, in an air-conducting manner, the common aeration unit with the fill opening of the container of the respective cover unit of the plurality of cover units.

### BRIEF DESCRIPTION OF THE DRAWINGS

The terms FIG., FIGS., Figure, and Figures are used interchangeably in the specification to refer to the corresponding figures in the drawings.

In the following, exemplary embodiments of the invention are described in detail using the schematic drawings. Thereby shown are:

FIG. 1 a block diagram of an example of an inkjet printing device;

FIGS. 2a through 2d an example of a cover unit for a print bar, in different states;

FIG. 3a the lowering of a print bar into a cover unit; and

FIG. 3b a print group having a plurality of print bars and cover units.

The non-limiting embodiments of the present invention will be described with reference to the accompanying drawings. Elements, features and components that are identical, functionally identical and have the same effect are, insofar as is not stated otherwise, respectively provided with the same reference character.

### DESCRIPTION OF THE INVENTION

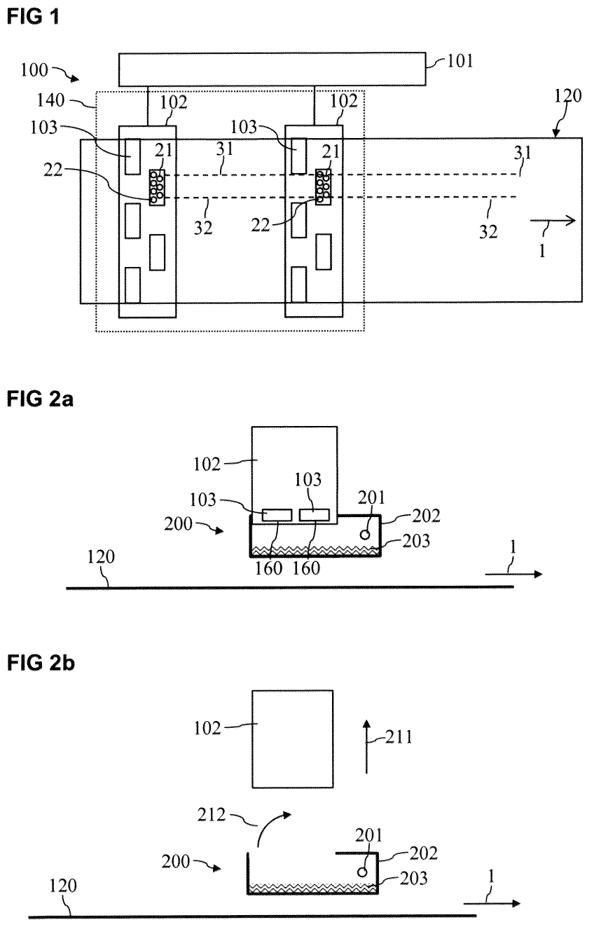

The printing device 100 depicted in FIG. 1 is designed for printing to a recording medium 120 in the form of a sheet or page or plate or belt. The recording medium 120 can be produced from paper, paperboard, cardboard, metal, plastic, textiles, a combination thereof, and/or other materials that are suitable and can be printed to. The recording medium 120 is directed through the print group 140 of the printing device 100 along the transport direction 1, which is represented by an arrow.

In the depicted example, the print group 140 of the printing device 100 comprises two print bars 102, wherein each print bar 102 can be used for printing with ink of a defined color, for example black, cyan, magenta, and/or yellow, and MICR ink if applicable. Different print bars 102 can be used for printing with respective different inks. Furthermore, the printing device 100 typically comprises at least one fixing or drying unit (not shown) that is configured to fix a print image printed onto the recording medium 120.

A print bar 102 can comprise one or more print heads 103 that, if applicable, are arranged side by side in a plurality of rows in order to print the dots of different columns 31, 32 of a print image onto the recording medium 120. In the example depicted in FIG. 1, a print bar 102 comprises five print heads 103, wherein each print head 103 prints the dots of a group of columns 31, 32 of a print image onto the recording medium 120.

In the embodiment depicted in FIG. 1, each print head 103 of the print group 140 comprises a plurality of nozzles 21, 22, wherein each nozzle 21, 22 is configured to fire or eject ink droplets toward the recording medium 120. A print head 103 of the print group 140 can, for example, comprise multiple thousands of effectively utilized nozzles 21, 22 that are arranged along a plurality of rows transverse to the transport direction 1 of the recording medium 120. Dots of a row of a print image 1 can be printed onto the recording medium 120 transverse to the transport direction 1, i.e. along the width of the recording medium 120, by means of the nozzles 21, 22 of a print head 103 the print group 140.

The printing device 100 also comprises a control unit 101, for example a driving hardware and/or a controller, that is configured to drive actuators of the individual nozzles 21, 22 of the individual print heads 103 of the print group 140 in order to apply a print image onto the recording medium 120 depending on print data. In an exemplary embodiment, the control unit 101 includes processing circuitry or at least one processor that is configured to perform one or more functions and/or operations of the control unit 101, including activating the actuators of the individual nozzles 21, 22 of the individual print heads 103 of the print group 140 to apply the print image onto the recording medium 120 based on print data, processing print and/or other data, control one or more modes of the printer device 100 and/or controlling one or more operations of the printing device 100. In an exemplary embodiment, the control unit 101 includes one or more interfaces (e.g. a wired and/or wireless input and/or output interface, transceiver, or the like) that are configured to receive or output data or information. For example, the control unit 101 may receive signals generated by one or more components of the printing device 100 (e.g. from a user interface of the printer device 100) and/or output control signals to one or more components of the printing device 100. In an exemplary embodiment, the control or processing unit 101 includes a memory configured to store data/information, and/or store executable code that is executable by the processing circuitry to cause the processing circuitry or at least one processor to perform the operation(s) of the control unit 101.

The print group 140 of the printing device 100 thus comprises at least one print bar 102 having K nozzles 21, 22 that can be driven with a defined line timing in order to print a line with K pixels or K columns 31, 32 of a print image onto the recording medium 120, for example with K>1000, said line running transverse to the transport direction 1 of the recording medium 120. In the presented example, the nozzles 21, 22 are installed immobile or fixed in the printing device 100, and the recording medium 120 is directed past the stationary nozzles 21, 22 with a defined transport velocity.

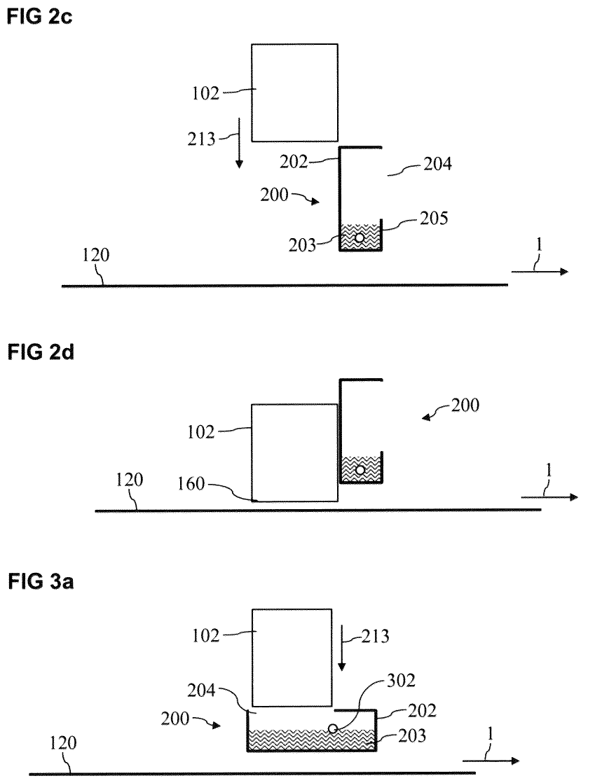

The printing device 100 can have a respective cover unit 200, if applicable for every single print head 103 or for the print heads 103 of a print bar 102, with which the nozzle plate 160 of at least one print head 103 can be covered if the printing device 100 is in a rest mode (see FIGS. 2a through 2d). The cover unit 200 of a print bar 102 can be designed as a flap that can be folded onto the nozzle plate 160 of the at least one print head 103 of the print bar 102 or, respectively be folded away from the nozzle plate 160 of the at least one print head 103 of the print bar 102 (as depicted in FIGS. 2a through 2d). The cover unit 200 can therefore also be referred to as a park flap or as a protective flap.

The cover unit 200 can comprise a container 202 with a print bar opening 204, wherein the nozzle plate 160 of a print head 103 of the print bar 102 can be guided through the print bar opening 204 into or onto the container 202. In particular, the print bar opening 204 of the container 202 can be designed such that the container 202 can be sealed by the nozzle plate 160 of a print head 103 and/or by the print bar 102, in order to form an in particular fluid-tight sealed container 202 when the nozzle plate 160 and/or the print bar 102 has been guided into or onto the container 202. In this instance, the nozzle plate 160 of a print head 103 and/or the print bar 102 represent a portion of the wall of the container 202 and face toward the interior space of the container 202.

The cover unit 200 can be configured to provide defined climatic conditions for the nozzle plate 160 of a print head 103 via which the drying up of ink in the nozzles 21, 22 of the print head 103 can be at least slowed or reduced. In particular, the interior space of the container 202 of the cover unit 200 can have a conditioning fluid 203, in particular a conditioning liquid, via which defined climatic conditions can be created in the interior space of the container 202 of the cover unit 200. For example, a relatively high humidity, in comparison to the humidity outside of the container 202 of the cover unit 200, can be created via the conditioning fluid 203. The conditioning fluid 203 can comprise demineralized water, for example. The functionality of a print head 103 can be reliably and efficiently preserved over relatively long rest time periods via the use of a conditioning fluid 203.

FIG. 2a shows a print bar 102 in a view orthogonal to the transport direction 1. The print bar 102 has a plurality of print heads 103, with a respective nozzle plate 160, that are covered by the cover unit 200. The print bar 102 is located in a rest or park position in which it should be acted upon by the cover unit 200 so that the ink within the print heads 103 of the print bar 102 does not dry out, or dries out only more slowly.

In order to transfer the print bar 102 into a printing position, the print bar 102 can be lifted in a raising direction 211 so that the container 202 of the cover unit 200 can be raised about the rotation axle 201 of the container 202, along the rotation direction 212 (see FIG. 2b). The container 202 of the cover unit 200 can then be raised so that the upright container 202 is arranged before or after the print bar 102 in the transport direction 1 of the recording medium 120, as is depicted in FIG. 2c. The print bar 102 can then be lowered along the lowering direction 213 past the upright container 202, in order to position the nozzle plates 160 of the one or more print heads 103 of the print bar 102 directly over a recording medium 120, as depicted in FIG. 2d. Only a relatively small nip is then found between the nozzle plates 160 of the one or more print heads 103 and the recording medium 120, for example 2 mm, 1 mm, or less. The print bar 102 is then located in the printing position. As is clear from FIGS. 2a through 2d, the print bar 102 can be moved back and forth between the rest or park position and the printing position via an efficient translation movement, in particular an up-and-down movement.

The container 202 of the cover unit 200 typically has on its side the print bar opening 204 for the print bar 102 and, at the end at which the rotation axle 201 is arranged, a wall segment 205 that is designed such that the placed container 202 forms a trough to receive the conditioning fluid 203, in particular to receive the conditioning liquid. It can thus be ensured that the conditioning fluid 203 remains in the container 202 even in the raised state of said container 202.

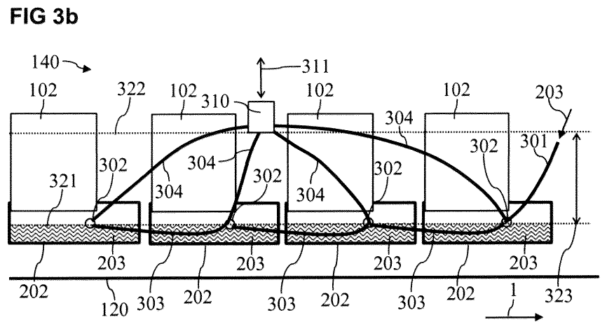

FIG. 3a shows an example of a cover unit 200 for a print bar 102 in a situation in which the print bar 102 is lowered along the lowering direction 213 in order to place the nozzle plates 160 of the one or more print heads 103 of the print bar 102 in the print bar opening 204 of the cover unit 200. The lowering of the print bar 102 takes place with a defined lowering velocity.

FIG. 3a also shows a fill opening 302 of the cover unit 200 via which conditioning liquid 203 can be filled into the container 202 of the cover unit 200. The fill opening 302 can be arranged at a defined height 321 above the floor of the container 202 (see FIG. 3b). The fill level, and thus the quantity of conditioning liquid 203 in the container 202, can be established by the height 321 of the fill opening 302. In a filling process, the container 202 can be filled with conditioning liquid 203 up to the height 321 of the fill opening 302. Further details with regard to the filling process are presented on conjunction with FIG. 3b.

At the moment at which the lower region of the print bar 102 at which the nozzle plates 160 of the one or more print heads 103 are arranged is introduced into the print bar opening 204 of the cover unit 200, the lowering of the print bar 102 with the lowering velocity leads to an overpressure in the container 202 of the cover unit 200. This overpressure can lead to conditioning liquid 203 being pushed out of the container 202 via the fill opening 302.

FIG. 3b illustrates a print group 140 having a plurality of print bars 103 and a corresponding plurality of cover units 200. The individual cover units 200 respectively have a fill opening 302 for filling the container 202 of the respective cover unit 200 with conditioning liquid 203. Conditioning liquid 203 can be directed via a fill line 302 into the fill opening 302 of the first cover unit 200 of a first print bar 102. If the container 202 of the first cover unit 200 is filled with conditioning liquid 203 up to the fill opening 302, the conditioning liquid 203 flows via a connecting line 303 from the fill opening 302 of the first cover unit 200 to the fill opening 302 of the second cover unit 200 for the second print bar 102. As a result of this, the container 202 of the second cover unit 200 is filled with conditioning liquid 203 up to the height of the fill opening 302. As soon as the filling of the container 202 of the second cover unit 200 is concluded, conditioning liquid 203 flows via an additional connecting line 303 from the fill opening 302 of the second cover unit 200 to the fill opening 302 of the third cover unit 200 for the third print bar 102.

A cascade to fill the containers 202 of the plurality of cover units 200 for the plurality of print bars 102 can be provided accordingly. The filling process is ended when the container 202 of the cover unit 200 of the last print bar 102 is filled with conditioning liquid 203 up to the height 321 of the fill opening 302.

The filling of the containers 202 of the individual cover units 200 can be achieved while the individual print bars 102 are arranged in cover units 200 corresponding to the print bar openings 204. In order to ensure a reliable ventilation of the container 202 upon filling, the container 202 of the individual cover units 200 can respectively have an aeration line via which air 311 can be directed out of the respective container 202. The aeration lines 304 can respectively be arranged at the fill opening 302 of the respective container 200. The aeration lines 304 can also respectively be coupled with an aeration unit 310. The individual aeration lines 304 can thus respectively run between the fill opening 302 of the container 202 of a cover unit 200 and the aeration unit 310. A common aeration unit 310 can thereby advantageously be used for the plurality of cover units 200.

The aeration unit 310 can be designed to control the volumetric flow of air 311 into and/or out of the containers 202 of the individual cover units 200. The volumetric flow of air 311 into the individual containers 202 can thereby be limited, whereas the volumetric flow of air 311 out of the individual containers 202 is essentially unlimited or is limited only to a reduced extent. On the one hand, a reliable filling can thus be enabled, and on the other hand a dilution of the conditioning liquid 203 can be reliably avoided.

The aeration unit 310 can be designed as an air filter in order to filter air 311 that is introduced into the individual containers 202. A contamination of the cover units 200 can thus be reliably avoided.

Alternatively or additionally, the aeration unit 310 can be designed as a sound absorber in order to damp flow noises of the inflowing and/or outflowing air 311.

The overpressure that is produced upon lowering of the print bars 102 into the containers 202 of the individual cover units 200 can lead to conditioning liquid 203 being pushed out of the individual containers 202, into the aeration lines 304, via the respective fill opening 302. This could lead to conditioning liquid 203 arriving in the aeration unit 310, whereby the aeration unit 310 can be negatively affected. In order to reliably avoid a negative effect on the aeration unit 310, the aeration unit 310 is preferably arranged at a height 322 that is arranged at a defined height difference 323 above the height 321 of the fill openings 302 of the individual cover units 200. The height difference 323 is thereby typically dependent on the overpressure that can be maximally produced in the individual cover units 200. The maximum possible overpressure is typically dependent on the lowering velocity of the individual print bars 102.

As has already been presented further above, an overpressure in the respective park flap, i.e. cover unit 200, is created upon parking the print bar 102 in the respective park position. Due to this overpressure, conditioning liquid 203, for example deionized water, i.e. demineralized water, that is located in the respective park flap 200 can be flung upward by the cascade in the direction of the aeration unit 310. The aeration unit 310 can thereby become wet and fouled and can clog over time. Often, a mixture of conditioning liquid 203 and ink is located in the individual park flaps 200, since ink from the one or more print heads 103 of the respective print bar 102 can drop in the parked state. This additionally accelerates the fouling and the clogging of the aeration unit 10. As a result of an impaired aeration unit 310, the conditioning of the one or more print heads 103 in the parked state can be negatively affected, which can lead to the drying up of nozzles 21, 22 given a relatively long stoppage of the printing device 100.

Via the aeration and ventilation of the cover units 200 as depicted in FIG. 3b, and via the use of an aeration unit 310 set relatively high up, said aeration unit preferably supplying a plurality of cover units 200, a fouling and clogging of the aeration unit 310 can be reliably avoided. The conditioning liquid 203 that is flung upward, which occurs upon parking the print bars 102, cannot reach the relatively high-up aeration unit 310. The service life of the aeration unit 310 can thereby be increased.

A print group 140 for an inkjet printing device is thus described. The print group 140 comprises at least one print bar 102 having at least one print head 103. The print bar 102 typically comprises a plurality of print heads 103 that, for example, are arranged side by side relative to the transport direction 1 in order to increase the print width of the printing device 100.

The print group 140 also comprises a cover unit 200 for the print bar 102. The cover unit 200 is designed to cover the nozzle plate 160 of the print head 103 of the print bar 102 with a container 202 in the park position of said print bar 102. For this purpose, the container 202 has a print bar opening 204 in which the print bar 102 can be placed. The cover unit 200 is also designed to receive conditioning liquid 203 into the container 202. The conditioning liquid 203 can comprise, in particular can be, demineralized water.

The container 202 of the cover unit 200 can be designed in order to be rotated about a rotation axle 201 so that the container 202 can, via a rotation about the rotation axle 201, be arranged in an upright state or in a cover state. In the cover state, the nozzle plate 160 of the print head 103 of the print bar 102 can be received in the print bar opening 204 of the container 202 and thereby be covered. On the other hand, in the upright state the container 202 can be arranged after or before the print bar 102, along the transport direction 1, such that the print bar 102 can be lowered past the container 202 toward the recording medium 120, in order to transfer the print bar 102 from the park position into the printing position, as is described by way of example in FIGS. 2a through 2d.

The print group 140 also comprises an aeration unit 310, preferably precisely a single aeration unit 310, that is connected via an aeration line 302, in an air-conducting manner, with the fill opening 302 of the container 202 of the cover unit 200. The aeration unit 310 is thereby preferably arranged with a defined height difference 323 above the fill opening 302 so that conditioning liquid 203 that, upon transferring the print bar 102 into the park position, is pressed through the fill opening 302 into the aeration line 302 due to the overpressure that is thereby created in the container 202 does not or cannot reach the aeration unit 310.

The aeration unit 310 can be designed to filter air 311 that is conducted from the outside into the container 202 of the cover unit 200 via the aeration unit 310 and via the aeration line 304. A particularly gentle parking of the print bar 102 can thus be produced.

Alternatively or additionally, the aeration unit 310 can is designed as a sound absorber. In particular, the aeration unit 310 can be designed to damp flow noises from air 311 in the aeration line 304. The comfort of the print group 140 can thus be increased.

Alternatively or additionally, the aeration unit 310 can be designed to more strongly limit the volumetric flow of air 311 from outside into the aeration line 304 via the aeration unit 310, in particular by a factor of 2 or more, than a volumetric flow 311 of air 311 out of the aeration line 304 via the aeration unit 310. A particularly gentle parking of the print bar 102 can thus be produced (even for a relatively long park duration).

Upon transferring the print bar 102 into the park position, the print bar 102 can be placed with a defined lowering velocity into the print bar opening 204 of the container 202 of the cover unit 200, wherein the lowering velocity is typically established by the design of the print group 140. The height difference 323 can be dependent on the lowering velocity and can in particular increase with increasing lowering velocity. In other words, the height difference 323 can have been established depending on the lowering velocity.

A print group 140 for an inkjet printing device 100 is thus described that has at least one print bar 102 with a cover unit 200 for the print bar 102, wherein the cover unit 200 is designed to cover the print bar 102 with an ambient climate produced by a conditioning liquid 203 when the print bar 102 is arranged in the park position. The print group 140 also comprises an aeration unit 310 that is connected with the cover unit 200 via an aeration line 304. The aeration unit 310 is preferably arranged so high above the conditioning liquid 203 that no conditioning liquid 203 can arrive at the aeration unit 310 via the aeration line 310 upon transferring the print bar 102 into the park position. A negative effect on the aeration unit 310 can thus be reliably avoided.

The print group 140 can comprise a fluid line 301, 303, for example a fill line 301 or a connection line 303, that is connected to the fill opening 302 and that is designed to conduct conditioning liquid 203 from outside the container 202 of the control unit 200 into the container 202 via the fill opening 302. The control unit 101 of the print group 140, or of the printing device 100, can be configured to cause the container 302 to be filled with conditioning liquid 203, in particular by means of a pump, via the fluid line 301, 303 up to—in particular precisely up to—the height 321 of the fill opening 302. The ambient climate in the container 202 of the cover unit 200 can thus be precisely adjusted.

The print group 140 preferably comprises a plurality of print bars 102 and a plurality of cover units 200 for the corresponding plurality of print bars 102. Furthermore, the print group 140 can comprise a plurality of aeration lines 302 for the corresponding plurality of cover units 200. The individual aeration lines 302 of the plurality of aeration lines 302 can thereby respectively connect, in an air-conducting manner, the aeration unit 310 with the fill opening 302 of the container 202 of the respective cover unit 200 of the plurality of cover units 200. The print group 140 preferably has only a single aeration unit 310 for the plurality of cover units 200.

A common aeration unit 310 can thus be used for the plurality of cover units 200. A particularly efficient print group 140 can thus be provided.

The plurality of print bars 102 and the corresponding plurality of cover units 200 can respectively be arranged one after another along the transport direction 1. The print group 140 can have a respective connection line 303 between two successively arranged cover units 200, which connection line 303 connects the fill openings 302 of the containers 200 of the two cover units 200 with one another in a fluid-conducting manner. This can take place in particular such that a cascade of cover units 200 is formed by the plurality of cover units 200, which cascade can be filled with conditioning liquid 203 gradually starting from a first cover unit 200 of the cascade of cover units 200. The filling of the container 202 of the plurality of cover units 200 can thus be achieved particularly efficiently.

According to a further aspect, a further print group 140 for an inkjet printing device 100 is described. The measures described in this document are also applicable to this print group 140 individually or in combination.

The print group 140 comprises a plurality of print bars 102, wherein the individual print bars 102 of the plurality of print bars 102 respectively comprise at least one print head 103. Furthermore, the print group 140 comprises a plurality of cover units 200 for the corresponding plurality of print bars 102. In the park position of the respective print bar 102 of the plurality of print bars 102, the individual cover units 200 of the plurality of cover units 200 are respectively designed to cover the nozzle plate 160 of the print head 103 of the respective print bar 102 with a container 202, and to receive conditioning liquid 203 into the container 202 of the respective cover unit 200.

The print group 140 also comprises an aeration unit 310 and a plurality of aeration lines 302 for the corresponding plurality of cover units 200. The individual aeration units 302 of the plurality of aeration lines 302 respectively connect the common aeration unit 310 in an air-conducting manner with the fill opening 302 of the container 202 of the respective cover unit 200 of the plurality of cover units 200.

Furthermore, in this document an inkjet printing device 100 is described that comprises at least one of the print groups 140 described in this document.

### REFERENCE LIST

1 transport direction (of the recording medium)
21, 22 nozzle
31, 32 column (of the print image)
100 printing device
101 control unit
102 print bar
103 print head
120 recording medium
140 print group
160 nozzle plate
200 cover unit (park flap)
201 rotation axle
202 container
203 conditioning fluid, in particular conditioning liquid
204 print bar opening
205 wall segment
211 raising direction
212 rotation direction
213 lowering direction
301 fluid line (fill line)
302 fill opening
303 fluid line (connection line)
304 aeration line
310 aeration unit
311 air
321 height of the fill opening/fill level (conditioning fluid)
322 height of the aeration unit
323 height difference of the aeration unit above the fill opening

1. A print group for an inkjet printing device, the print group comprising:
at least one print bar having at least one print head;
a cover unit for the print bar, wherein
the cover unit is configured to, in a park position of the print bar, cover a nozzle plate of the print head of the print bar with a container;
the cover unit is further configured to receive conditioning liquid into the container; and
an aeration unit that is connected in an air-conducting manner, via an aeration line, with a fill opening of the container of the cover unit,
wherein the aeration unit is arranged with a height difference above the fill opening so that conditioning liquid that is pressed through the fill opening into the aeration line upon transferring the print bar into the park position does not reach the aeration unit.

2. The print group according to claim 1, wherein
the container of the cover unit has a print bar opening;
upon transferring the print bar into the park position, the print bar is placed with a defined lowering velocity into the print bar opening of the container of the cover unit; and
the height difference is dependent on the lowering velocity, and increases with increasing lowering velocity.

3. The print group according to claim 1, wherein the print group comprises:
a fluid line that is connected to the fill opening and that is configured to conduct conditioning liquid from outside the container of the cover unit through the fill opening into the container; and
a control unit that is configured to actuate a pump such that the container is filled with conditioning liquid via the fluid line up to a height of the fill opening.

4. The print group according to claim 1, wherein
the aeration unit is configured to filter air that is conducted from outside into the container of the cover unit via the aeration unit and via the aeration line.

5. The print group according to claim 1, wherein
the aeration unit is configured as a sound absorber.

6. The print group according to claim 1, wherein
the aeration unit is configured to damp flow noises from air in the aeration line.

7. The print group according to claim 1, wherein
the aeration unit is configured to more limit a volumetric flow of air from outside into the aeration line via the aeration unit by a factor of 2 or more than a volumetric flow of air from the aeration line to the outside via the aeration unit.

8. The print group according to claim 1, wherein the print group comprises
a plurality of print bars;
a plurality of cover units for the corresponding plurality of print bars; and
a plurality of aeration lines for the corresponding plurality of cover units; wherein the individual aeration lines of the plurality of aeration lines respectively connect, in an air-conducting manner, the aeration unit with the fill opening of the container of the respective cover unit of the plurality of cover units.

9. The print group according to claim 8, wherein the print group has only a single aeration unit for the plurality of cover units.

10. The print group according to claim 8, wherein
the plurality of print bars and the corresponding plurality of cover units are respectively arranged one after another along a transport direction of a recording medium to be printed to by the print group;
the print group has a respective connection line between two cover units arranged in direct succession, which connection line connects the fill openings of the containers of the two cover units with one another in a fluid-conducting manner.

11. The print group according to claim 10, wherein
the respective connection line connects the fill openings of the containers of the two cover units with one another in a fluid-conducting manner such that a cascade of cover units is formed that can be filled gradually with conditioning liquid, starting from a first cover unit of the cascade of cover units.

12. The print group according to claim 1, wherein the container of the cover unit is configured
to be rotated about a rotation axle so that the container is arranged in an upright state or in a cover state via rotation about the rotation axle;
in the cover state, to receive the nozzle plate of the print head of the print bar in a print bar opening of the container and to thereby cover it; and
in the upright state, to be placed after or before the print bar along a transport direction of a recording medium to be printed to by the print group, such that the print bar is lowered past the container toward the recording medium in order to transfer the print bar from the park position into a printing position.

13. The print group according to claim 1, wherein the conditioning liquid comprises demineralized water.

14. A print group for an inkjet printing device, the print group comprising
a plurality of print bars; wherein individual print bars of the plurality of print bars respectively comprise at least one print head;
a plurality of cover units for the corresponding plurality of print bars, wherein
individual cover units of the plurality of cover units are respectively configured to, in a park position of the respective print bar of the plurality of print bars, cover a nozzle plate of the print head of the respective print bar with a container;
the individual cover units are respectively configured to receive conditioning liquid into the container of the respective cover unit;
an aeration unit; and
a plurality of aeration lines for the corresponding plurality of cover units; wherein individual aeration lines of the plurality of aeration lines respectively connect, in an air-conducting manner, the aeration unit with a fill opening of the container of the respective cover unit of the plurality of cover units.
